(19) United States
(12) Patent Application Publication
(10) Pub. No.: US 2016/0319466 A1
(43) Pub. Date: Nov. 3, 2016

(54) POROUS CELLULOSE NANOFIBERS METHOD OF PREPARATION

(71) Applicants: Zeeshan Khatri, Jamshoro (PK); Umaima Saleem, Jamshoro (PK); Farooq Ahmed, Jamshoro (PK)

(72) Inventors: Zeeshan Khatri, Jamshoro (PK); Umaima Saleem, Jamshoro (PK); Farooq Ahmed, Jamshoro (PK)

(21) Appl. No.: 14/699,899

(22) Filed: Apr. 29, 2015

(51) Int. Cl. D01F 2/28; D01F 11/06; D01D 5/00; D01F 6/16; B01D 39/18; B01D 29/00

(52) U.S. Cl. CPC D01F 2/28; B01D 39/18; B01D 29/0093; D01D 5/0007; D01F 6/16; D01F 11/06; B01D 2239/025

(57) ABSTRACT

A method of preparing a porous cellulose nanofibers, the method including electro spinning of blend polymers solutions and forming nanofibers, removing acetyl content and one polymer component from the electrospun nanofibers during deacetylation process creating porous cellulose nanofibers. Nanofibers having nanoporous structures are particularly attractive for filtration purposes and membranes.

### BACKGROUND OF THE INVENTION

This invention relates to a porous cellulose nanofibers mats applicable for liquid filtration, where high wicking rates are required. The porous cellulose nanofibers are also applicable to organic solvent filtration such as chloroform, dimethylformamide, ethanol, methanol, acetone, toluene etc. and a method of preparing the same. Nano fibers with their porous structure and high surface-to-volume ratio are highly promising materials for filtration.

Fiber electrospinning is a process where nanofibers are formed by polymer melt or polymer solution using an electro statistically driven jet. More than 50 polymers have been made into nanofibers by using this technique. It is an easy and versatile technique for producing nanofibers or nanowebs continuously. Electrospinning has opened a new application perspective for polymeric materials including cellulose nanofibers that can be tailored to suit the appropriate need.

Since cellulose is very difficult to dissolve in many solvents, which limits its use in electrospinning, the conversion of Cellulose acetate (CA) into cellulose nanofibers is an easier route to prepare cellulose nanofibers.

Cellulose acetate can be electro spun into nanofibers for application in biomedical areas and filtration. Porous nanofibers are particularly suitable far filtration purposes. Layers of nanofibers have high permeability, low basic weight and small pore size that enables them to be used for various filtration applications. In the area of biotechnology, cellulose nanofibers have applications in bio-sensing, bio-separation, crop protection, biomolecule immobilization, bioremediation, tissue engineering and in the development of anti-bacterial and pH sensitive material, temperature-adaptable fabric, and photo-catalytic self-cleaning textile.

Current interest is in consolidated membrane structures with porosities ranging from 30 to 60%. Typical capillary flow liquid expulsion porometry measurements indicate that pore throat diameters range from 0.1 to 0.8 μm in size. It is believed that porosity in cellulose nanofibers results in high flux rate.

### BRIEF SUMMARY OF THE INVENTION

The present invention is directed to provide porous cellulose nanofibers for liquid filtration, which has 3D morphology with bead free nanofibers, excellent physical properties and a high wicking rate.

One aspect of the present invention provides a method of preparing a porous cellulose nanofibers. The method includes electrospinning of blend polymers solutions and forming nanofibers (operation 1). Removing acetyl content and one polymer component from the electro spun nanofibers during deacetylation process created porous cellulose nanofibers (operation 2, 3 and 4).

The diameters of electro spun nanofibers were in the range 200 nm to 600 nm. In the present invention, the Poly (L-LacticAcid) (PLLA) is at least one selected from the Cellulose Acetate/Poly (L-LacticAcid) blends consisting of 2:1, 3:1 and 4:1 blend ratios. Another aspect of the present invention provides organic solvent filtration with enhanced wicking rate, solvent include, chloroform, dimethylformamide, ethanol, methanol, acetone, toluene etc.

### BRIEF DESCRIPTION OF THE DRAWING

FIG. 1 depicts the main idea.

FIG. 2 depicts the method of preparation for porous cellulose nanofibers (Operation 1 to 3).

FIG. 3 depicts the Scanning Electron Microscopic image of the nanofibers web as elctrospun obtained before deacetylation.

FIG. 4 depicts scanning Electron Microscopic image of the porous cellulose nanofibers obtained after deacetylation.

FIG. 5 depicts the Fourier Transform Infrared spectra of nanofiber webs before deacetylation.

FIG. 6 depicts the Fourier Transform Infrared spectra of porous nanofiber webs after deacetylation.

FIG. 7 depicts the wicking rate between Cellulose Acetate and Cellulose nanofibers.

FIG. 8 depicts the wicking rate of CA/PLLA (2:1) nanofibers and porous cellulose nanofibers.

FIG. 9 depicts the wicking rate of CA/PLLA (3:1) nanofibers and porous cellulose nanofibers.

FIG. 10 depicts the wicking rate of CA/PLLA (4:1) nanofibers and porous cellulose nanofibers.

FIG. 11 depicts the comparison of wicking Rate, wicking rate of porous cellulose nanofibers prepared according to their respective composition CA/PLLA (2:1) CA/PLLA (3:1) CA/PLLA (4:1).

FIG. 12 depicts WAXD pattern of cotton fabric depicted as Cellulose-I.

FIG. 13 depicts WAXD pattern of porous cellulose nanofibers depicted as Cellulose-II.

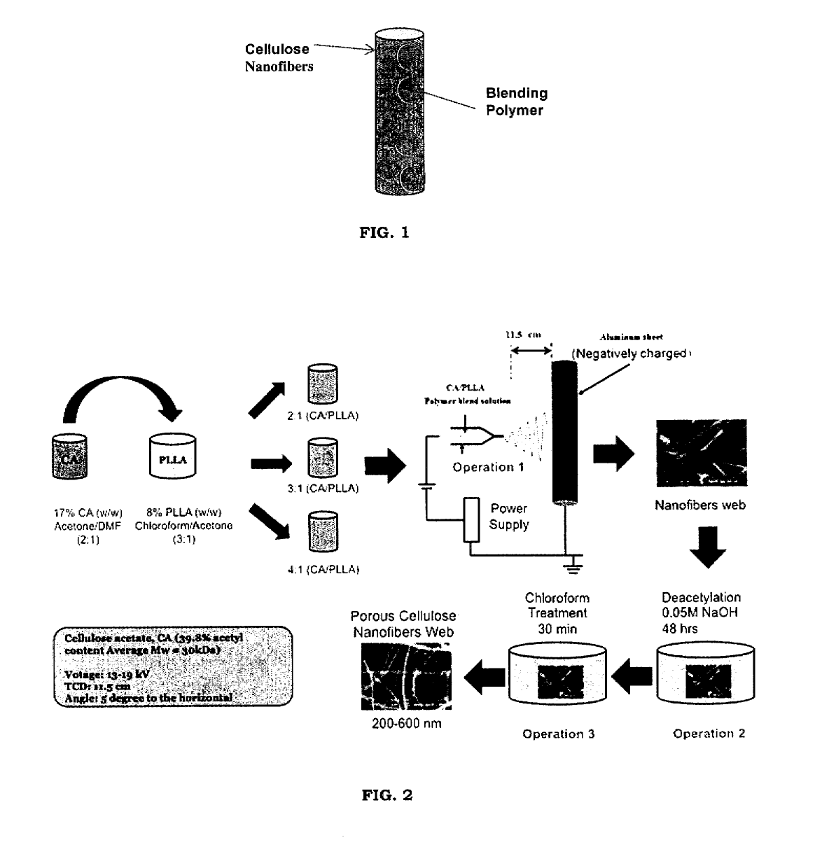

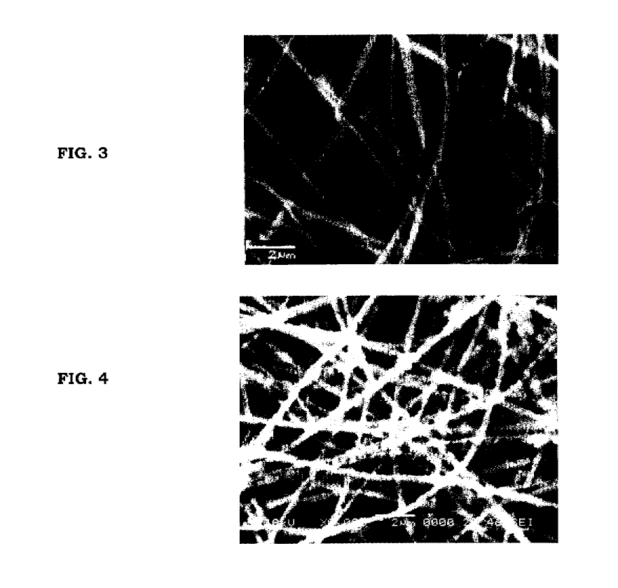

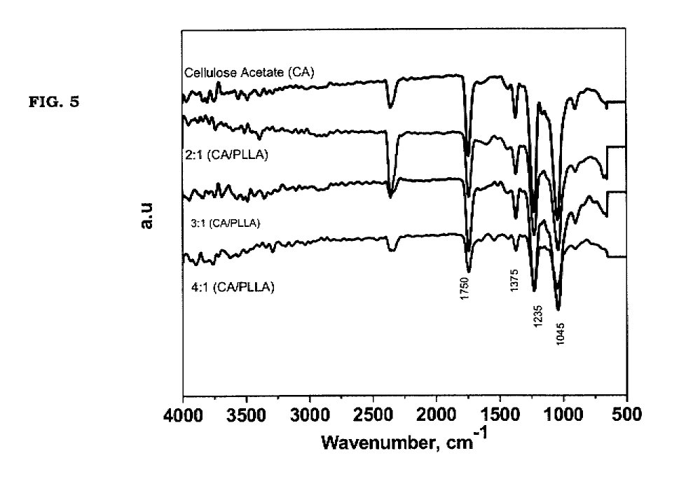

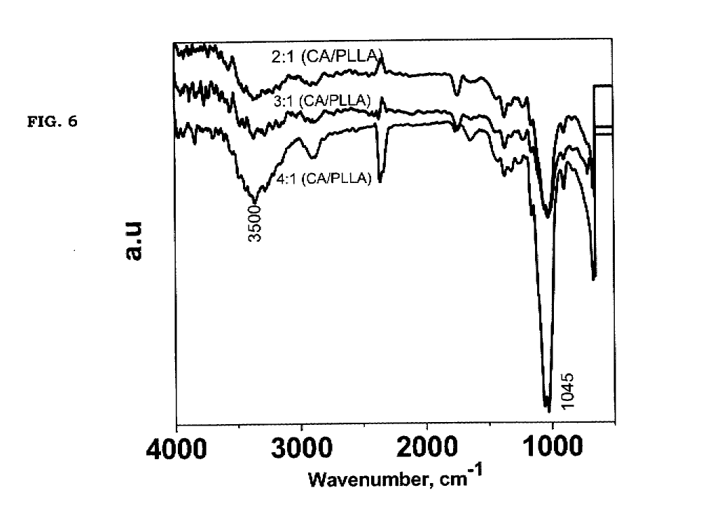

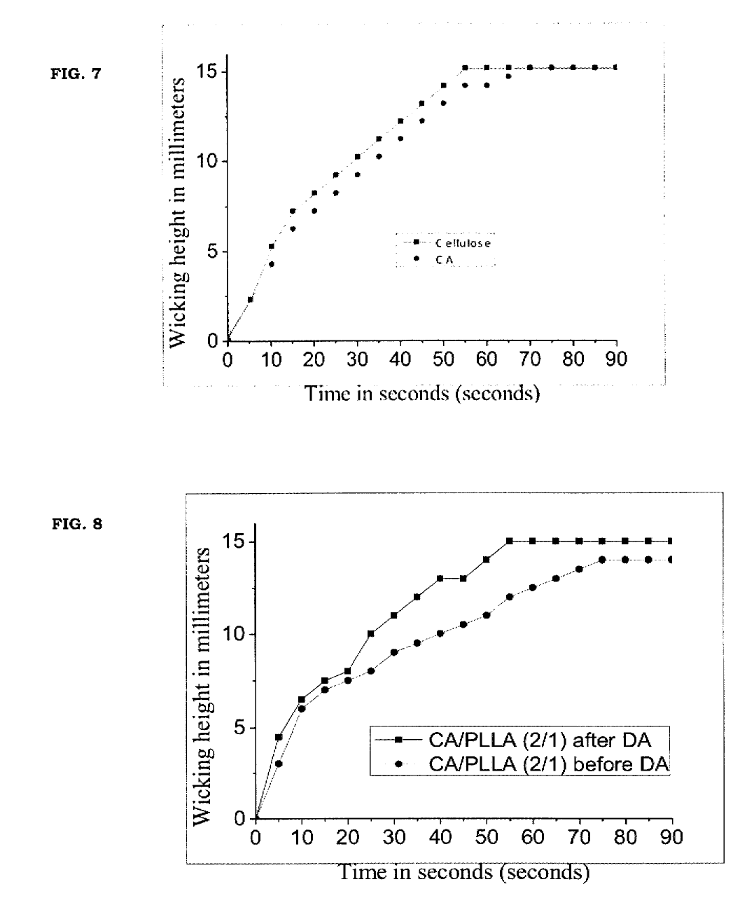

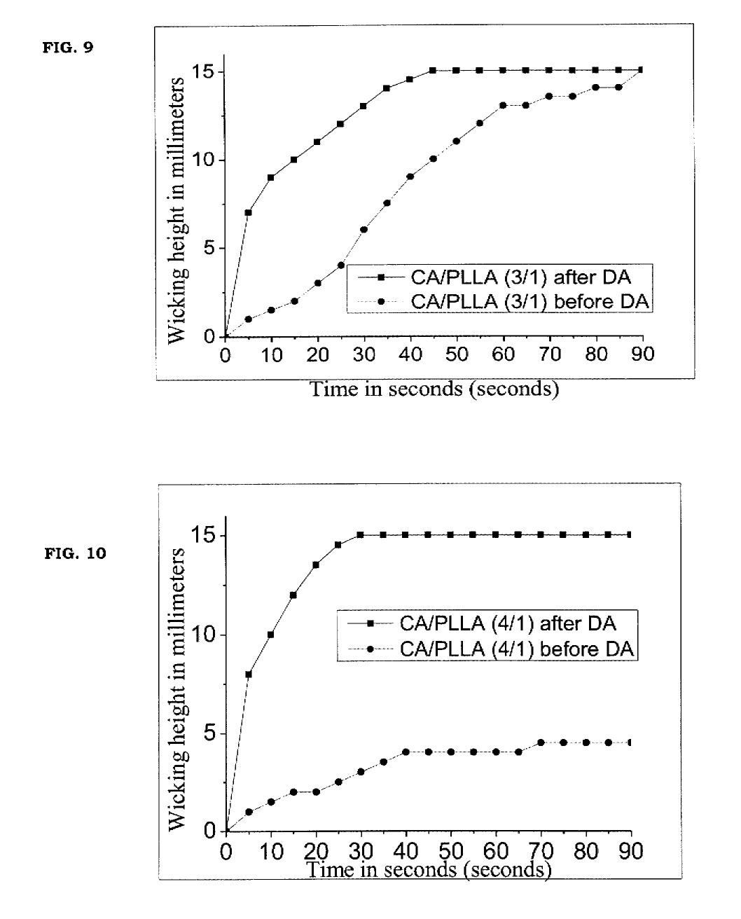

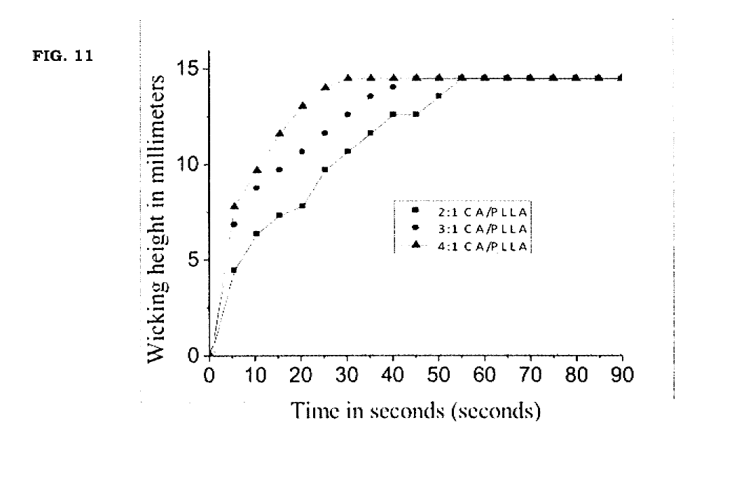

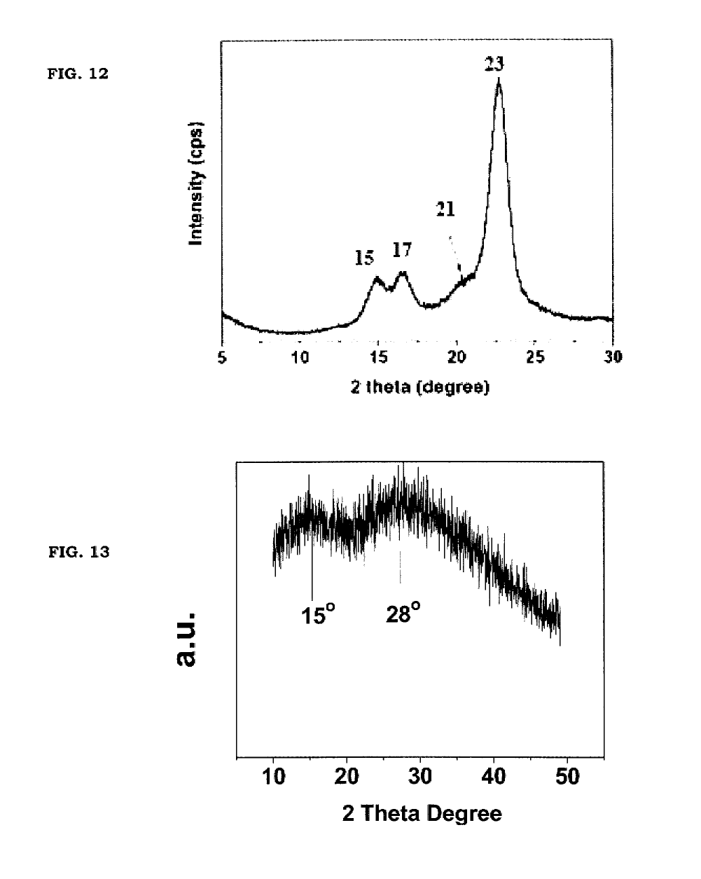

### DETAILED DESCRIPTION OF THE INVENTION

Cellulose Acetate (CA) of acetyl content of 39.8% M.Wt 30 kDa was used without any further purification. Poly (L-LacticAcid) (PLLA) having M.Wt 143,000 was used to create porosity in cellulose nanofibers.

The concentration of CA was 17% by weight and prepared in acetone/dimethyl formamide (DMF) with 2:1 by weight while the PLLA solution 8% (w/w) was prepared by dissolving in binary solvent mixture of Chloroform and Acetone (3:1).

Three blends solutions of CA/PLLA as 2:1, 3:1, 4:1 at 50° C. were mixed and stirred for at least 24 hours and in addition, neat CA solution was also prepared.

Each solution was electrospun to form nanofibers. Electrospinning unit comprises of a high voltage power supply (Har-100*12, Matsusada company from Tokyo, Japan.

The neat CA and CA/PLLA blend solutions were filled in a plastic syringe attached with a capillary tip having 0.6 mm diameter. A copper wire was inserted in to the polymer solution which is connected to the positive electrode (anode), and the collector (mandrel) is connected to the negative (cathode). The supplied voltage for neat CA solution was fixed at 13 kV, whereas the range for blending ratios of CA/PLLA was 16-19 kV. The tip of needle to mandrel that was covered with aluminum foil distance was fixed at 11.5 cm and 10° angle was set for the plastic syringe above horizontal (Operation 1).

Electrospun nanofibers were deposited continuously over Aluminum foil or a black paper for 2-10 hours. The thickness of the nanofibers webs was between 20-60 μm.

The diameters of electrospun nanofibers were in the range 200 nm to 600 nm. This explains the method of creating pores in electrospun nanofibers. Deacetylation of all nanofibers was carried out under aqueous hydrolysis by soaking them in 0.05M. NaOH solution for 48 hours at room temperature. During this operation, CA nanofibers were converted in to pure cellulose nanofibers and also PLLA was removed from the CA/PLLA blend nanofibers webs (Operation 2). For complete removal PLLA content from porous cellulose nanofibers, each sample was soaked further in Chloroform for 30 minutes at room temperature (Operation 3). The porous cellulose nanofibers were dried under vacuum for 12 hours to remove solvents contents (Operation 4).

What is claimed is:

1. A method for manufacturing porous nano fibers comprising:
preparing a porous nanofiber web from a mixture of cellulose acetate and poly (L-lactic acid);
converting cellulose acetate into cellulose by treating the nanofiber web with a solution of sodium hydroxide;
removing poly (L-lactic acid) by extraction using chloroform;
drying the nanofiber web in step c under vacuum to remove any residual solvent.

2. The method of claim 1, wherein the cellulose acetate is converted into cellulose by soaking the nanofiber web in a 0.05M solution of sodium hydroxide for 48 hours.

3. The method of claim 1, wherein poly (L-lactic acid) is removed by soaking the nanofiber in chloroform for 30 minutes after converting cellulose acetate into cellulose.

4. The method of claim 1, wherein the nanofiber web is made by a process of electrospinning.

5. The method of claim 1, wherein the porous nanofiber web is prepared by using a mixture of cellulose acetate and poly (L-lactic acid) in proportions of 2:1, 3:1 or 4:1.

6. The method of claim 1, wherein the porous nanofiber web is totally deacetylated.

7. The method of claim 1, wherein the cellulose in the porous nanofiber has Cellulose II conformation.

8. The method of claim 1, wherein the pores in the porous nanofiber web range between 200 and 600 nm.
